(19) United States
(12) Patent Application Publication
(10) Pub. No.: US 2017/0198866 A1
(43) Pub. Date: Jul. 13, 2017

(54) OMNI-DIRECTIONAL LED LIGHT BULB

(71) Applicant: Yi-Pyng Gau, Hsinchu City (TW)

(72) Inventor: Yi-Pyng Gau, Hsinchu City (TW)

(21) Appl. No.: 14/993,098

(22) Filed: Jan. 12, 2016

(51) Int. Cl. F21K 99/00; F21V 23/00

(52) U.S. Cl. CPC F21K 9/1355; F21V 23/003

(57) ABSTRACT

An omni-directional LED light bulb, mainly connecting a head to the bottom of a main body and a base to the top thereof, and the main body being covered with a glass cover, characterized in that a mounting column has a height about the half height of glass cover; a circuit board with a plurality of LEDs respectively configured on the top face and bottom face thereof is in connection with the top end of the mounting column, the LEDs being flip chips and in electric connection with one another and electric elements inside the main body; the base and mounting column are made from material excellent in heat conduction, and the main body is made from material excellent in cooling, thereby allowing the LED light bulb to illuminate in all directions.

### TECHNICAL FIELD OF THE INVENTION

The present invention relates to an LED light bulb, and more particularly to an omni-directional LED light bulb, capable of emitting light in all directions

### DESCRIPTION OF THE PRIOR ART

Global warming is becoming more and more serious such that energy saving and carbon dioxide reduction is a major issue that all countries in the world are advocating recently, allowing every kind of environmentally protective product to be valued. In terms of lighting equipment, conventional incandescent bulbs were mostly used for the lighting in the past. But, they do not meet the environmental requirements of energy saving and carbon dioxide reduction, mainly because they will convert 90% of energy to heat energy during illumination, and only 10% thereof to generate light, resulting in low luminous efficacy, and wasting resources seriously.

Currently, there are many light bulbs equipped with LED's as light emitting sources are more commonly seen in the market. But, such kinds of light bulbs still have disadvantages mostly caused from the deficiencies of structural designs thereof; light emitters thereof are levelly placed circuit boards on which a plurality of LED's are configured. However, such kinds of LED light bulbs have light emitting angles smaller than 180°, only reaching half of omni-directional light source effect, the dead angles of illumination being large, light unevenness happening easily such that they only can be used as downlights, the light efficiencies and light illuminations of which are very poor if arranged in pairs with upward illumination or horizontal insertion type lamps.

With the progress of technology, one kind of omni-directional LED light bulb is designed to solve the defects of semi-spatial LED light bulb, but current common omni-directional LED light bulbs have their own defects in structure. Such kinds of omni-directional LED light bulbs, as FIG. 1 shows, are mainly constituted by a main body with cooling fins in connection with light emitter and covered with a lamp housing, characterized in that the emitter is formed by attaching a plurality of circuit boards on the surface of a Three-dimensional multi-faceted base configured on the center of the top face of the main body, where each two adjacent circuit boards are connected with an electric wire and further in electric connection with electric elements inside the main body, and several LEDs are distributed on each circuit board so that the illumination range of all LEDs can be expanded greatly by facing the circuit boards on the three-dimensional emitter toward respective different directions, thereby allowing the LED light bulb to have a better illumination effect. However, the illumination angle of the LED light bulb of such kind of arrangement can only reach 180°, and the illumination angle thereof is the minimum of an omni-directional LED light bulb, only little better than semi-spatial LED light bulb, the dead angles of illumination being still large, uneven light still happening such that they are merely suitable to be used as downlight lamps. Moreover, light efficiency and light illumination are not ideal if they are arranged in pairs with upward illumination or horizontal insertion type lamps. In addition, the cooling effect of the LED light bulb of such configuration is not good.

### SUMMARY OF THE INVENTION

An omni-directional LED light bulb according to the present invention may almost illuminate in all directions, leading to the illumination with much less dead angles, having more uniformity in such a way to ensure the comfort of the illumination, and the installment in a larger space, and this is the object of the present invention.

To achieve the object mentioned above, present invention proposes an omni-directional LED light bulb, mainly connecting a head to the bottom of a main body and a base to the top thereof, and the main body being covered with a glass cover, characterized in that a mounting column has a height being about the half height of glass cover; a circuit board with a plurality of LEDs respectively configured on the top face and bottom face thereof is in connection with the top end of the mounting column, the LEDs being flip chips and in electric connection with one another and electric elements inside the main body; the base and mounting column are made from material excellent in heat conduction, and the main body is made from material excellent in cooling, thereby allowing the LED light bulb to illuminate in all directions.

### BRIEF DESCRIPTION OF THE DRAWINGS

FIG. 1 is a schematically perspective view of a conventional LED light bulb;

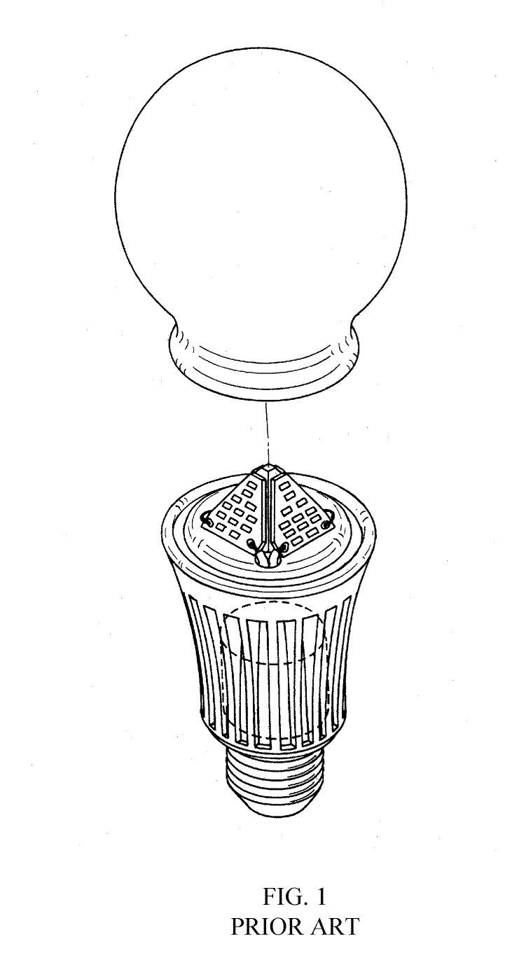

FIG. 2 is a schematically perspective view of an LED light bulb according to the present invention;

FIG. 3 is a schematic view of the LED light bulb according to the present invention; and

FIG. 4 is a schematically perspective view of another preferred embodiment of an LED light bulb according to the present invention.

### DETAILED DESCRIPTION OF THE PREFERRED EMBODIMENTS

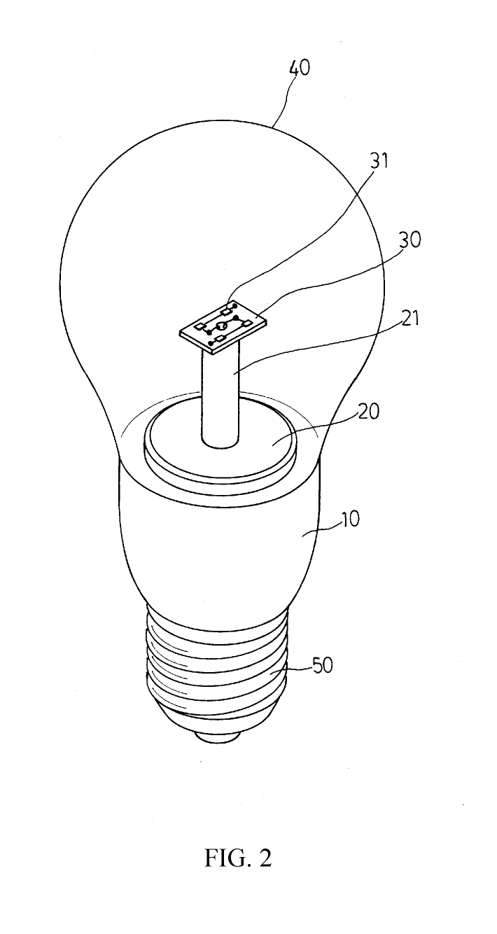

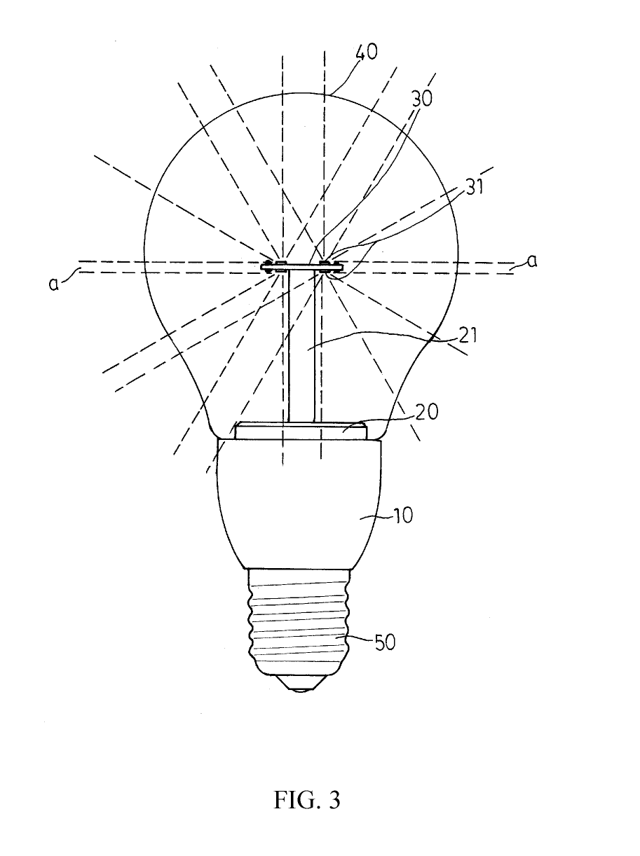

Referring to FIGS. 2 and 3, an omni-directional LED light bulb of the present invention mainly comprises a main body 10, base 20, circuit board 30, glass cover 40 and head 50, where the main body 10 is made from a material having an excellent cooling effect (e.g. plastics of superhigh thermal conductivity), and required electric elements (not shown in the figures) are installed inside the main body 10; the base 20 is in connection with the main body 10, and the glass cover 40 is covered on and connected to the base 20; the head 50 is in connection with the bottom of the main body 10 and in electric connection with the electric elements inside the main body 10; a mounting column 21 of a height about half the height of the glass cover 40, and a circuit board 30 with a plurality of LEDs 31 respectively configured on the top face and bottom face thereof is in connection with the top end of the mounting column 21, where all the LEDs 31 are connected electrically together with conducting wires, and in electric connection with the electric elements inside the main body 10. In particularly, the circuit board 20 is made from ceramics excellent in heat conduction, and base 20 and mounting column 21 all are also made from materials (e.g. aluminum) excellent in heat conduction. Furthermore, LEDs 31 are 170° five-sided light emitting SMD LED formed by flip chips attached to both top and bottom faces of the circuit board 30, allowing the circuit board 20 to form a highly efficient lamp board. In addition, the circuit board 21 is mounted in the central position of the bulb, capable of illuminating in all directions, and the dark zone a generated thereby is very small such that the LED light bulb of the present invention is really an omni-directional light bulb.

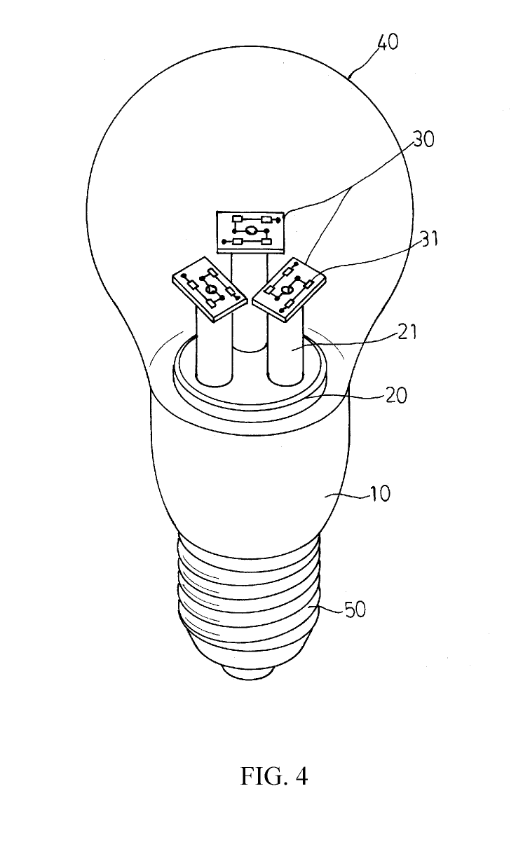

The mounting columns 21 configured on the base 20 of an omni-directional LED light bulb of the present invention is not limited to only one; they can be configured multiply, and a circuit board 30 having a plurality of LEDs 31 respectively configured on both top face and bottom face thereof is in connection with the top end of each mounting column 21. In an embodiment, there are three mounting columns 21 are configured, as FIG. 4 shows.

I claim:

1. A omni-directional LED light bulb, comprising a main body, base, circuit board, glass cover and head, required electric elements being configured inside said main body; said base being in connection with a top of said main body and covered with said glass cover; said head being configured on a bottom of said main body, and in electric connection with said electric elements inside said main body; a mounting column of a height about half the height of said glass cover being configured on said base; said circuit board being in connection with a top end of said mounting column and in the central position of said bulb, and a plurality of LEDs being respectively configured on a top face and bottom face of said circuit board; all said LEDs being in electric connection with one another with conducting wires and said electric elements inside main body.

2. The light bulb according to claim 1, wherein a plurality of mounting columns are configured on said base, and a circuit board having a plurality of LEDs respectively configured on a top face and bottom is in connection with said top end of each said mounting column.
